(19) United States
(12) Patent Application Publication
(10) Pub. No.: US 2020/0150804 A1
(43) Pub. Date: May 14, 2020

(54) TOUCH SUBSTRATE AND METHOD OF FABRACATING THE SAME, TOUCH DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Jiangsheng Wang, Beijing (CN); Jianjun Wu, Beijing (CN)

(21) Appl. No.: 16/518,961

(22) Filed: Jul. 22, 2019

(30) Foreign Application Priority Data
Nov. 12, 2018 (CN) 201811340233.0

(51) Int. Cl. G06F 3/041

(52) U.S. Cl. CPC G06F 3/0412; G06F 2203/04103

(57) ABSTRACT

A touch substrate and a method of fabricating the same, and a touch display device are disclosed. The touch substrate includes: a base layer having a touch function region and a non-touch function region adjacent to at least one edge of the touch function region; a plurality of touch electrodes disposed on the base layer and located in the touch function region; and a plurality of connection pads disposed on the base layer and located in the non-touch function region, the plurality of connection pads being electrically connected to the plurality of touch electrodes through a plurality of wires, respectively, wherein the base layer is bendable at the non-touch function region such that the plurality of connection pads are located on a side of the base layer away from the plurality of touch electrodes in response to the base layer being in a bent state.

### CROSS-REFERENCE TO RELATED APPLICATION

This application claims the benefit of Chinese Patent Application No. 201811340233.0 filed on Nov. 12, 2018 in the State Intellectual Property Office of China, the whole disclosure of which is incorporated herein by reference.

### TECHNICAL FIELD

The present disclosure relates to the field of touch and display technologies, and in particular, to a touch substrate and a method of fabricating the same, a touch display device.

### BACKGROUND

With the development of touch technology, display devices with touch function are widely used in various fields, and touch display devices with a narrow frame are increasingly favored by people.

### SUMMARY

Some embodiments of the present disclosure provide a touch substrate comprising: a base layer having a touch function region and a non-touch function region adjacent to at least one edge of the touch function region; a plurality of touch electrodes disposed on the base layer and located in the touch function region; and a plurality of connection pads disposed on the base layer and located in the non-touch function region, the plurality of connection pads being electrically connected to the plurality of touch electrodes through a plurality of wires, respectively, wherein the base layer is bendable at the non-touch function region such that the plurality of connection pads are located on a side of the base layer away from the plurality of touch electrodes in response to the base layer being in a bent state.

In some embodiments, the non-touch function region comprises: a first region adjacent to one edge of the touch function region; and a second region adjacent to the first region and located on a side of the first region away from the one edge, wherein a size of the second region is smaller than a size of the first region in a direction in which the one edge extends, and wherein the plurality of connection pads are disposed in the second region, and the base layer is bendable at the second region such that the base layer is in a bent state and the plurality of connection pads are located on the side of the base layer away from the plurality of touch electrodes in response to the base layer being in the bent state.

In some embodiments, the plurality of connection pads are arranged in the direction in which the one edge extends, and are spaced apart from each other, and a distance between the one edge and any one of the plurality of connection pads is greater than or equal to 0.9 mm.

In some embodiments, the second region is adjacent to a central portion of the first region, the central portion being located in the middle of the first region in the direction in which the one edge extends.

In some embodiments, the second region is in a shape of rectangle.

In some embodiments, the plurality of touch electrodes comprise a plurality of first touch electrodes extending in a first direction and a plurality of second touch electrodes extending in a second direction.

In some embodiments, the plurality of first touch electrodes are driving electrodes, and the plurality of second touch electrode are sensing electrodes; or the plurality of first touch electrode are sensing electrodes, and the plurality of second touch electrode are driving electrodes.

In some embodiments, each of the plurality of first touch electrodes comprises a plurality of first touch sub-electrodes arranged in the first direction, and any two adjacent first touch sub-electrodes being electrically connected to each other; and each of the plurality of second touch electrodes comprises a plurality of second touch sub-electrodes arranged in the second direction, any two adjacent second touch sub-electrodes being electrically connected to each other.

In some embodiments, each of the plurality of first touch sub-electrodes and each of the plurality of second touch sub-electrodes are disposed in the same layer, made of the same material and insulated from each other.

In some embodiments, any two adjacent first touch sub-electrodes are electrically connected by a first connection portion, the first connection portion and the plurality of first touch sub-electrodes being disposed in the same layer and made of the same material.

In some embodiments, the touch substrate further comprising: an insulating layer covering the first connection portion; and a second connection portion on the insulating layer, wherein any two adjacent second touch sub-electrodes are electrically connected by the second connection portion.

In some embodiments, at least one of the plurality of wires comprises a first conductive layer and a second conductive layer stacked on the first conductive layer.

In some embodiments, the first conductive layer, the plurality of first touch sub-electrodes and the plurality of second touch sub-electrodes are disposed in the same layer and made of the same material, and the second conductive layer comprises a metal material.

In some embodiments, an orthographic projection of the second conductive layer on the base layer falls within an orthographic projection of the first conductive layer on the base layer, and a line width of the second conductive layer is smaller than a line width of the first conductive layer.

In some embodiments, the base layer is made of a flexible material.

Some embodiments of the present disclosure provide a touch display device comprising: a display panel comprising a display face; the touch substrate of claim 1 on the display face of the display panel, the side of the base layer away from the plurality of touch electrodes being arranged to face the display face; and a circuit board bonded to the plurality of connection pads, wherein the base layer is bendable at the non-touch function region such that the plurality of connection pads and the circuit board are located on the side of the base layer away from the plurality of touch electrodes in response to the base layer being in the bent state.

In some embodiments, the touch substrate is adhered onto the display face by a transparent optical adhesive.

In some embodiments, the display face comprises a display region, and an orthographic projection of the display region on the base layer falls within the touch function region of the base layer.

Some embodiments of the present disclosure provide a method of fabricating a touch substrate, comprising: adhering a base layer covered with a touch electrode material layer to a rigid substrate; patterning the touch electrode material layer to form a plurality of touch electrodes in a touch function region of the base layer; forming a plurality of connection pads and a plurality of wires in a non-touch function region of the base layer adjacent to at least one edge of the touch function region by a patterning process, the plurality of wires electrically connecting the plurality of connection pads with the plurality of touch electrodes; and peeling off the rigid substrate.

In some embodiments, the method further comprising: cutting the base layer after peeling off the rigid substrate such that the non-touch function region comprises a first region adjacent to one edge of the touch function region; and a second region adjacent to the first region and located on a side of the first region away from the one edge, a size of the second region being smaller than a size of the first region in a direction in which the one edge extends.

### BRIEF DESCRIPTION OF THE DRAWINGS

FIG. 1 is a schematic structural view of a touch substrate according to some embodiments of the present disclosure;

FIG. 2 is a schematic structural view of a touch substrate when a base layer is in a bent state according to some embodiments of the present disclosure;

FIG. 3 is a partial cross-sectional view of a touch substrate of FIG. 1 taken along line A-A;

FIG. 4 is a partial cross-sectional view of a touch substrate of FIG. 1 taken along line B-B;

FIG. 5 is a flow chart of a method of fabricating a touch display device according to some embodiments of the present disclosure;

FIG. 6 is a schematic side view of a touch display device according to some embodiments of the present disclosure;

FIG. 7 is a schematic structural view of a touch substrate bonded to a circuit board according to some embodiments of the present disclosure.

FIG. 8 is a schematic plan view of a display panel of the touch display device of FIG. 6; and

FIG. 9 is a flow chart of a method of fabricating a touch display device according to some embodiments of the present disclosure.

### DETAILED DESCRIPTION OF EMBODIMENTS

In order to enable those skilled in the art to understand the technical schemes of the present disclosure well, the present disclosure will be further described in detail below in conjunction with the accompanying drawings and specific embodiments.

In the present disclosure, “patterning process” refers to a step of forming a structure having a specific pattern, it may be a photolithography process including one or more steps selected from steps of forming a material layer, coating a photoresist, exposing, developing, etching, stripping the photoresist or the like. Optionally, the “patterning process” may be other processes such as an imprint process, an inkjet printing process or the like.

In the present disclosure, an expression “two structures being disposed in the same layer” may mean that the two structures are formed of the same material layer so that they are in the same layer in the layered relationship, but it neither means that the two structures are apart from a substrate at the same distance, nor means that layers between the substrate and one of the two structures are identical in structure to layers between the substrate and the other one of the two structures.

In the related art, a touch display device in which a touch substrate is stacked on a display panel is taken as an example. Generally, a wire connected to a touch electrode in a touch function region (corresponding to a display region of the display panel) extends into a non-touch function region (i.e., a peripheral region) out of the touch function region, and is electrically connected to a connection pad located in a bonding region. A bonding region of a flexible circuit board (FPC) is bonded at the bonding region of the touch substrate, so that the connection pad (i.e., gold finger) is electrically connected to a gold finger of the flexible circuit board. When the touch display device is assembled, a portion of the flexible circuit board except the bonding region needs to be bent to a side of the display panel away from the touch substrate. In this case, the bonding region is located on a display face side of the touch display device.

In a fabricating process, the bonding region cannot cover the wire, however there may be some errors in a position of the flexible circuit board during the bonding process, so the a size of the bonding region of the touch substrate should be larger than a size of the bonding region of the flexible circuit board, for example, about 0.15 mm larger, to avoid a short circuit of the wire caused by the positional errors of the flexible circuit board. Further, in order to ensure the electrical conductivity of the connection pad and to prevent breakage at a bonding position between the flexible circuit board and the connection pad, a size of the connection pad should not be too small, for example, a length of the connection pad is not less than 0.55 mm. As a result, a frame of the touch display device has to be set relatively wide.

Based on the above problems, some embodiments of the present disclosure provide a touch substrate including: a base layer having a touch function region and a non-touch function region adjacent to at least one edge of the touch function region; a plurality of touch electrodes disposed on the base layer and located in the touch function region; a plurality of connection pads disposed on the base layer, located in the non-touch function region, and electrically connected to the plurality of touch electrodes through a plurality of wires, respectively. The base layer is bendable at the non-touch function region such that the plurality of connection pads are located on a side of the base layer away from the plurality of touch electrodes in response to the base layer being in a bent state. A touch display device including the touch substrate may have a narrow frame to improve the user experience.

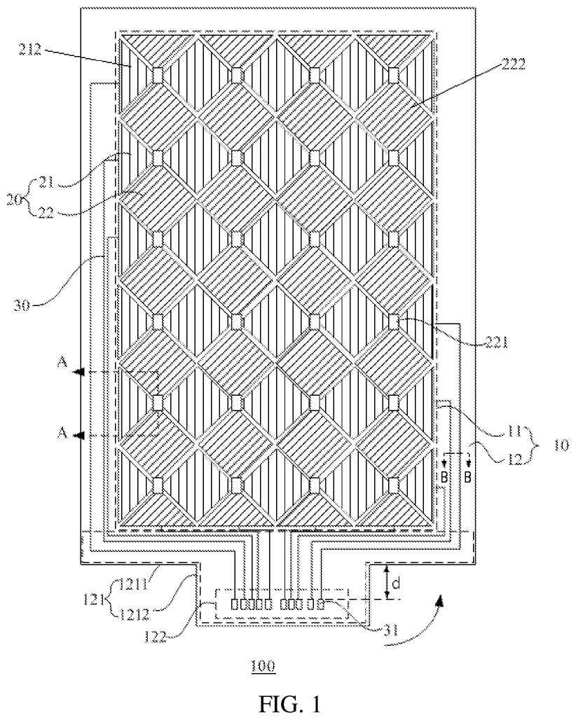

FIG. 1 is a schematic structural view of a touch substrate according to some embodiments of the present disclosure. As shown in FIG. 1, some embodiments of the present disclosure provide a touch substrate 100 including a base layer 10, a plurality of touch electrodes 20, a plurality of connection pads 31 and a plurality of wires 30. The plurality of touch electrodes 20, the plurality of connection pads 31 and the plurality of wires 30 are all located on the base layer 10.

The base layer 10 has a touch function region 11 and a non-touch function region 12 adjacent to at least one edge of the touch function region 11. For example, the touch function region 11 is located in an intermediate area of the base layer 10, and surrounded by the non-touch function region 12.

The plurality of touch electrodes 20 are disposed in the touch function region 11. The plurality of connection pads 31 are disposed in a connection region 122 (i.e., bonding region) in the non-touch function region 12. A first end of each of the plurality of wires 30 is electrically connected to one of the plurality of touch electrodes 20, and a second end of each of the plurality of wires 30 is electrically connected to one of the plurality of connection pads 31 (i.e., gold fingers) located in the connection region 122.

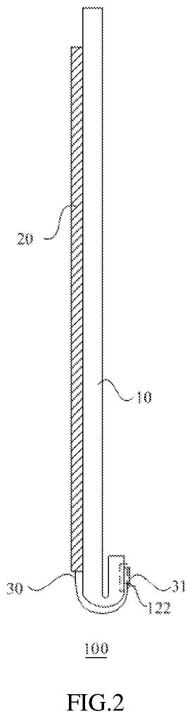

The base layer 10 is bendable at the non-touch function region 12 (the bending direction is indicated by an arrow in FIG. 1), so that the connection region 122 is located on a side of the base layer 10 away from the plurality of touch electrodes 20 in response to the base layer 10 being in the bent state. FIG. 2 shows a schematic view of the touch substrate when the base layer 10 is in the bent state.

In some embodiments, the touch function region 11 of the base layer 10 may be rectangular, and the non-touch function region 12 of the base layer 10 may be adjacent to only some edges of the touch function region 11, or may be adjacent to four edges of the touch function region 11, that is, the non-touch function region 12 is disposed around the touch function region 11, and surrounds the touch function region 11. As shown in FIG. 1, if the touch function region 11 is rectangular, in the following description, a first portion of the non-touch function region 12 in which the connection region 122 is located is referred to as a lower non-touch function region 121, a second portion of the non-touch function region 12 opposite to the lower non-touch function region 121 is referred to as an upper non-touch function region, and the remaining two portions of the non-touch function region 12 (i.e., a third portion and the fourth portion) are referred to as side non-touch function regions. Although the connection region 122 is located in the lower non-touch function region 121 in the embodiments shown in FIG. 1, the present disclosure is not limited thereto, the connection region 122 may also be located in the upper non-touch function region, or the side non-touch function regions.

The plurality of wires 30 are mainly used to electrically connect the plurality of touch electrodes 20 located in the touch function region 11 with the plurality of connection pads 31 located in the connection region 122 in the lower non-touch function region 121, so that a touch integrated circuit (IC) chip may supply signals to the respective touch electrodes 20 through the plurality of connection pads 31 in the connection region 122, and receive feedback signals. The plurality of wires 30 may include signal transmitting wires and signal receiving wires. The plurality of wires 30 may be metal wires or wires made of other suitable materials. The plurality of wires 30 may have a single layer structure, or a double layer structure, or a multilayer structure.

For convenience of description, in the following description, one side of the base layer 10 on which the touch electrodes 20 is disposed is referred to as a front side of the base layer 10, and one side of the base layer 10 away from the touch electrodes 20 is referred to as a back side of the base layer 10, that is, the base layer 10 can be bent toward the back side of the base layer 10 at the non-touch function region 12, specifically, at the lower non-touch function region 121, so that a position of the plurality of connection pads 31 in the connection region 122 of the lower non-touch function region 121 is changed from the front side of the base layer 10 to the back side of the base layer 10. In some embodiments, the bent state of the base layer 10 may be maintained by a bonding manner to hold the plurality of connection pads 31 in the connection region 122 on the back side of the base layer 10. In other embodiments, the touch substrate may be assembled with other structures such as a casing or the like, and the bent state of the base layer 10 is maintained by the casing or the like to hold the plurality of connection pads 31 in the connection region 122 on the back side of the base layer 10.

The base layer 10 of the touch substrate in the present embodiments is made of a flexible material, so it is bendable. The plurality of connection pads 31 in the connection region 122 are located on the back side of the base layer 10 by bending the base layer 10. Compared with the plurality of connection pads in the connection region being on the front side of the base layer in the related art, as seen from the front side of the base layer 10, in the touch substrate of the embodiments of the present disclosure, a size of the non-touch function region 12 (i.e., the lower non-touch function region 121) provided with the connection region 122 may be reduced, so that a touch display device having a narrow frame may be fabricated to improve the user experience.

In some embodiments, as shown in FIG. 1, the lower non-touch function region 121 where the connection region 122 is located includes a first region 1211 and a second region 1212. The first region 1211 is adjacent to one edge of the touch function region 11, for example, a lower edge; the second region 1212 is adjacent to the first region 1211 and located on a side of the first region 1211 away from the lower edge of the touch function region 11. In a direction in which the lower edge of the control function region 11 extends, a size of the second region 1212 is smaller than a size of the first region 1211. The connection region 122 is disposed in the second region 1212. The base layer 10 is bendable at the second region 1212, so that the plurality of connection pads 31 in the connection region 122 are on the side of the base layer 10 away from the touch electrodes 20 in response to the base layer 10 being in a bent state.

In some embodiments, the second region 1212 is adjacent to a central portion of the first region 1211, the central portion being located in the middle of the first region 1211 in the direction in which the one edge extends. That is, the second region 1212 is adjacent to a central portion of an edge, which is away from the touch function region 11, of the first region 1211.

In some embodiments, as shown in FIG. 1, the lower non-touch function region 121 has a shape formed by splicing two rectangles of different sizes. A first rectangle (i.e., the first region 1211) is directly adjacent to the touch function region 11, a second rectangle (i.e., the second region 1212) is connected to the first rectangle, and the first rectangle has a greater width than the second rectangle (the width here is a dimension in a direction parallel to the edge, which is adjacent to the first region 1211, of the touch function region 11). The connection region 122 is located in the second region 1212; and the second region is disposed at an intermediate position between two lateral edges of the base layer 10.

In this way, the plurality of connection pads 31 electrically connected to the second ends of the plurality of wires 30 may be distributed more densely, which facilitates the electrical connection between the plurality of connection pads 31 and the gold fingers of the flexible circuit board; also, the second region has a small width so that the base layer 10 is easily bent at the second region.

In some embodiments, as shown in FIG. 1, the plurality of connection pads 31 are arranged in the direction in which the lower edge of the touch function region 11 extends, and spaced apart from each other. Any of the plurality of connection pads is away from a boundary between the first area 1211 and the second area 1212 at a distance d which is greater than or equal to 0.9 mm, for example, equal to 1 mm. In this way, it may be ensured that the plurality of connection pads 31 are located on the side of the base layer 10 away from the touch electrode 20 of the base layer 10, rather than at a bent portion of the base layer 10, when the base layer 10 is in the bent state.

In some embodiments, as shown in FIG. 1, the plurality of touch electrodes 20 includes a plurality of first touch electrodes 21 disposed in a first direction, such as a row direction, and a plurality of second touch electrodes 22 disposed in a second direction, such as a column direction.

Each of the plurality of first touch electrodes 21 is connected to one of the wires 30. Specifically, a first end of the wire 30 connecting a second touch electrode 21 is connected to the first touch electrode 21 at a boundary between the side non-touch function region and the touch function region 11, and the wire 30 extends in the side non-touch function region such that a second end of the wire 30 extends into the lower non-touch function region 121. Each of the plurality of second touch electrodes 22 is connected to one of the wires 30, Specifically, a first end of the wire 30 connecting a second touch electrode 22 is connected to the second touch electrode 22 at a boundary between the lower non-touch function region 121 and the touch function region 11, and a second end of the wire 30 extends directly into the second region 1212 of the lower non-touch function region 121.

Such a structure may minimize a size of the side non-touch function region under the premise of ensuring the display effect, thereby further increasing the ratio of an area of the touch function region 11 to an area of the front side of the entire base layer 10.

In some embodiments, the first touch electrodes 21 are driving electrodes, and the second touch electrodes 22 are sensing electrodes; alternatively, the first touch electrodes 21 are sensing electrodes, and the second touch electrodes 22 are driving electrodes.

That is, one kind of the first touch electrodes 21 and the second touch electrodes 22 may be drive electrodes for providing drive signals in turn, and the other kind may be sensing electrodes for generating sensing signals according to the drive signals.

In some embodiments, each of the plurality of first touch electrodes 21 includes a plurality of first touch sub-electrodes 212 arranged in the first direction, such as the row direction, and adjacent first touch sub-electrodes 212 are electrically connected with each other. Each of the plurality of second touch electrodes 22 includes a plurality of second touch sub-electrodes 222 arranged in the second direction, such as the column direction, and adjacent second touch sub-electrodes 222 are electrically connected with each other.

Optionally, each of the first touch sub-electrodes 212 and each of the second touch sub-electrodes 222 are disposed in the same layer, made of the same material and insulated from each other.

Specifically, each of the first touch electrodes 21 and each of the second touch electrodes 22 may be respectively formed by multiple touch sub-electrodes (for example, diamond-shaped touch sub-electrodes in FIG. 1), and the touch sub-electrodes of each of the first touch electrodes 21 and the touch sub-electrodes of each of the second touch electrodes 22 are disposed in the same layer, made of the same material and insulated from each other (i.e., disposed at different positions and spaced apart from each other), so that the touch is detected by the sensing between adjacent edges of the first touch sub-electrodes 212 and the second touch sub-electrodes 222. For example, the first touch sub-electrodes 212 and the second touch sub-electrodes 222 may be in the form of a block of a transparent conductive material (such as indium tin oxide) or a metal mesh.

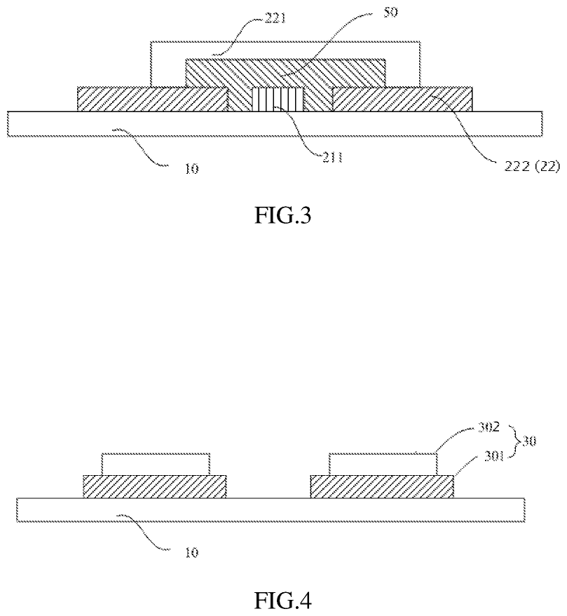

FIG. 3 is a partial cross-sectional view of the touch substrate of FIG. 1 taken along line A-A. In order to realize the electrical connection between adjacent first touch sub-electrodes in the same row and the electrical connection between adjacent second touch sub-electrodes in the same column, as shown in FIG. 1 and FIG. 3, any two adjacent ones of the first touch sub-electrodes 212 are directly electrically connected to each other through a first connection portion 211 which is disposed in the same layer as the touch sub-electrodes, and any two adjacent ones of the second touch sub-electrodes 222 are bridged by a second connection portion 221. Specifically, the first connection portion 211 is covered with an insulating layer 50, and the second connection portion 221 is disposed across the insulating layer 50 to electrically connect two adjacent second touch sub-electrodes, thereby forming a bridge structure.

In some embodiments, it should be understood that it is also feasible that the touch electrodes are in other forms (e.g., block-shaped self-capacitive touch electrodes).

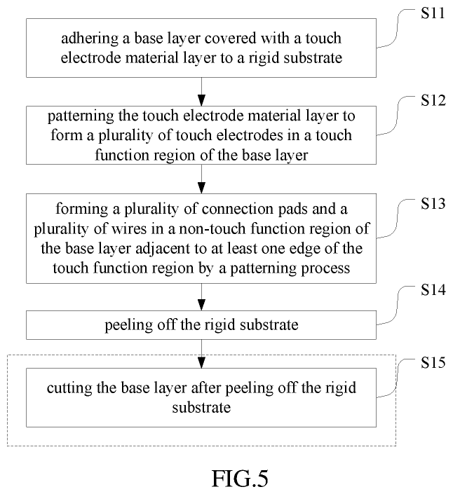

FIG. 4 is a partial cross-sectional view of the touch substrate of FIG. 1 taken along line B-B. In some embodiments, as shown in FIG. 4, each of the plurality of wires 30 has a double layer structure including a first conductive layer 301 and a second conductive layer 302 stacked on the first conductive layer 301. The first conductive layer 301 may be disposed in the same layer and made of the same material as the plurality of first touch sub-electrodes 212 and the plurality of second touch sub-electrodes 222, for example, made of a transparent conductive material such as ITO or ZnO. The second conductive layer 302 may be made of a metal material such as copper, silver or an alloy material. When the second conductive layer 302 is made of the alloy material, the corrosion resistance of the metal material can be ensured. Optionally, the second conductive layer 302 and the second connection portion 221 are disposed in the same layer and made of the same material, that is, they are formed by the same patterning process. The double layer structure of the wires 30 may improve the signal transmission capability and reduce the electrical signal attenuation. Meanwhile, the second conductive layer 302 made of the metal material is stacked on the first conductive layer 301 made of, such as ITO, which may prevent the second conductive layer 302 made of the metal material from being broken to ensure the conductive properties of the wires 30.

In some embodiments, as shown in FIG. 4, an orthographic projection of the second conductive layer 302 on the base layer 10 falls within an orthographic projection of the first conductive layer 301 on the base layer 10, and a line width of the second conductive layer 302 is less than a line width of the first conductive layer 301, for example, the line width of the second conductive layer 302 is 1 to 3 μm less than the line width of the first conductive layer 301. Therefore, the transmittance of the touch substrate is increased as much as possible while ensuring the conductive property of the wires 30.

FIG. 5 is a flowchart of a method for fabricating a touch substrate according to some embodiments of the present disclosure. As shown in FIG. 5 and referring to FIGS. 1 to 4, some embodiments of the present disclosure provide a method for fabricating the touch substrate in the foregoing embodiments. The method includes the following steps:

S11: adhering a base layer covered with a touch electrode material layer to a rigid substrate;

S12: patterning the touch electrode material layer to form a plurality of touch electrodes in a touch function region of the base layer;

S13: forming a plurality of connection pads and a plurality of wires in a non-touch function region of the base layer adjacent to at least one edge of the touch function region by a patterning process, the plurality of wires electrically connecting the plurality of pads with the plurality of touch electrodes; and

S14: peeling off the rigid substrate.

In step S11, since the base layer 10 is made of a flexible material, it is difficult to form other functional layers directly on the base layer 10. Therefore, firstly, the base layer 10 should be disposed on the rigid substrate. Specifically, the base layer 10 may be adhered to the rigid substrate by using a bonding material, such as optical clear adhesive (OCA), which has an effective viscosity in a temperature range of −5° C. to 10° C.

In these embodiments, the base layer 10 covered with the touch electrode material layer may be purchased directly. In other embodiments, the touch electrode material layer covering the entire base layer 10 is formed on the base layer 10 by deposition, evaporation, or the like, and the touch electrode material layer may be made of a transparent conductive material, such as ITO, ZnO, or the like.

In step S12, specifically, firstly, the base layer 10 covered with the touch electrode material layer is cleaned to remove impurities on a surface of the touch electrode material layer; and secondly, the plurality of touch electrodes 20 including a plurality of first touch electrodes 21 and a plurality of second touch electrodes 22 are formed in the touch function region 11 of the base layer 10 by using a patterning process. Each of the plurality of first touch electrodes 21 includes a plurality of first touch sub-electrodes 212 arranged in a first direction, such as a row direction, and adjacent first touch sub-electrodes 212 are electrically connected to each other; each of the plurality of second touch electrodes 22 includes a plurality of second touch sub-electrodes 222 arranged in a second direction, such as a column direction, and adjacent second sub-electrodes 222 are electrically connected to each other. In some embodiments, a first connection portion 211 is formed between any two adjacent ones of the first touch sub-electrodes 212. The first connection portion 211 is disposed in the same layer as the first touch sub-electrodes 212 and electrically connects any two adjacent ones of the first touch sub-electrodes 212; then, the base layer 10 is coated with a layer of insulating material, such as SiO2, SiN, etc., and then a patterning process is performed so that the insulating material remains only at the intersection of the first touch electrode 21 and the second touch electrode 22 (i.e., on the first connection portion 211) to form an insulating layer 50; then, a second connection portion 221 connecting any two adjacent ones of the second touch sub-electrodes 222 is formed on the insulating layer 50, so that the any two adjacent ones of the second touch sub-electrodes 222 are electrically connected.

In step S13, as shown in FIG. 1, a plurality of wires 30 and a plurality of connection pads 31 are formed on the base layer 10 by a patterning process such that the plurality of wires 30 electrically connect the plurality of touch electrodes 20 with the plurality of connection pads 31. The plurality of wires 30 and the connection pads 31 may be formed of the same material, for example, a metal material, by using the same patterning process.

In some embodiments, each of the plurality of wires 30 has a double layer structure including a first conductive layer 301 and a second conductive layer 302 stacked on the first conductive layer 301. The first conductive layer 301 may be disposed in the same layer and made of the same material as the plurality of first touch sub-electrodes 212 and the plurality of second touch sub-electrodes 222, for example, made of a transparent conductive material such as ITO or ZnO. The second conductive layer 302 may be made of a metal material such as copper, silver or an alloy material. Optionally, the second conductive layer 302 and the second connection portion 221 are disposed in the same layer and made of the same material, that is, they are formed by the same patterning process.

In step S14, since the base layer 10 is adhered to the rigid substrate by optical clear adhesive (OCA), the rigid substrate may be peeled off from the base layer 10 by changing temperature. Alternatively, the base layer 10 may be peeled off from the rigid substrate by laser lift-off manner or the like. Thereby, the touch substrate is obtained. Since the base layer 10 includes a flexible material, the base layer 10 is bendable at the non-touch function region 12 such that the plurality of connection pads 31 are located on the side of the base layer 10 away from the touch electrodes 20 in response to the base layer 10 being in the bent state.

In some embodiments, as shown in FIG. 5, the method of fabricating the touch substrate in the foregoing embodiments may further include:

S15: cutting the base layer after peeling off the rigid substrate.

In step S15, the lower non-touch function region 121 of the base layer 10 is cut into a shape as shown in FIG. 1. That is, the lower non-touch function region 121 includes the first region 1211 adjacent to the lower edge of the touch function region 11, and the second region 1212 adjacent to the first region 1211 and located on the side of the first region 1211 away from the lower edge of the touch function region 11. In the direction in which the lower edge of the touch function region 11 extends, the size of the second region 1212 is smaller than the size of the first region 1211.

The base layer 10 of the touch substrate fabricated by the method of the embodiments is bendable at the second region 1212, and the connection pad 31 in the connection region 122 is located on the back side of the base layer 10 by bending of the base layer 10. Compared with the plurality of connection pads in the connection region being on the front side of the base layer in the related art, as seen from the front side of the base layer 10, in the touch substrate of the embodiments of the present disclosure, the size of the non-touch function region 12 (i.e., the lower non-touch function region 121) in which the connection region 122 is located may be reduced, so that a touch display device having a narrow frame may be fabricated to improve the user experience.

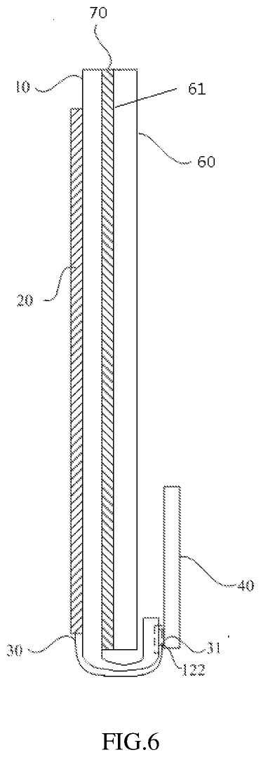

FIG. 6 is a schematic side view of a touch display device according to some embodiments of the present disclosure. As shown in FIG. 6, some embodiments of the present disclosure provide a touch display device including: a display panel 60, the touch substrate described in the foregoing embodiments (for example, as shown in FIG. 1), and a circuit board 40.

The display panel 60 includes a display face 61. The touch substrate 100 is disposed on the display face of the display panel, and the side of the base layer 10 away from the touch electrodes 20 faces the display face 61.

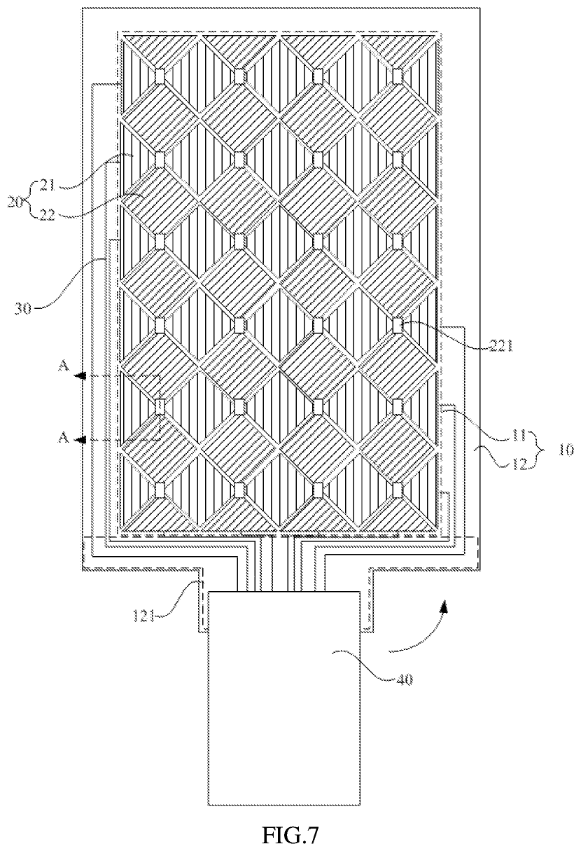

FIG. 7 is a schematic structural view of a touch substrate bonded to a circuit board according to some embodiments of the present disclosure. As shown in FIG. 1 and FIG. 7, the circuit board 40, for example, a flexible circuit board, is bonded to the plurality of connection pads 31 in the connection region 122, more specifically, gold fingers of the circuit board 40 are electrically connected to the connection pads 31 (for example, by an anisotropic conductive paste). The touch integrated circuit (IC) chip is disposed on the circuit board 40, and may supply signals to the respective touch electrodes 20 through the plurality of connection pads 31 in the connection region 122, and receive feedback signals to implement touch.

The base layer 10 is bendable at the second region 1212 of the lower non-touch function region 121, the circuit board 40 may located on a side of the display panel 60 away from the display face 61 as the base layer 10 is bent at the second region 1212. The touch display device thus formed has a narrow frame, which may improve the user experience.

In some embodiments, the touch substrate 100 is attached to the display face 61 of the display panel 60 through a transparent optical adhesive 70.

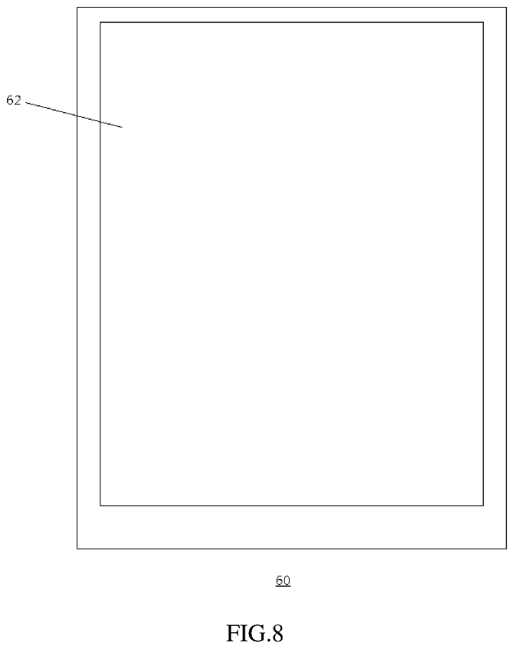

FIG. 8 is a schematic plan view of the display panel in the touch display device of FIG. 6. The display panel 60 may include a display region 62. The display region 62 of the display panel 60 corresponds to the touch function region 11 of the touch substrate 100. In some embodiments, an orthographic projection of the display region 62 on the base layer 10 falls within the touch function region 11 of the base layer 10. In other embodiments, an orthographic projection of the display region 62 on the base layer 10 coincides with the touch function region 11 of the base layer 10. Thereby, the touch display function of the touch display device may be ensured.

In some embodiments, the touch display device may also directly integrate a display pixel layer between the base layer 10 and the touch electrodes 20. The touch display device designed in this way does not need to provide an additional display panel, and is lighter and thinner.

It can be understood that the display panel may be a flat display panel such as an OLED panel, a PLED panel, an LCD panel or the like, and the touch display device may be any product or component having a display function such as an electronic paper, a mobile phone, a tablet computer, a television, a display screen, a notebook computer, a digital photo frame, a navigator or the like.

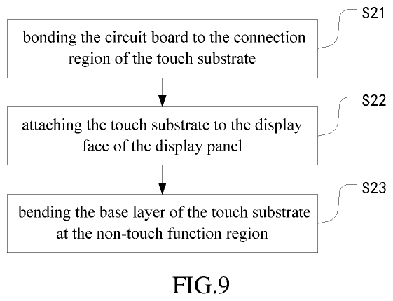

FIG. 9 is a flowchart of a method of fabricating a touch display device according to some embodiments of the present disclosure. As shown in FIG. 9, some embodiments of the present disclosure provide a method of fabricating the touch display device in the foregoing embodiments, including:

S21, bonding the circuit board to the connection region of the touch substrate;

S22, attaching the touch substrate to the display face of the display panel; and

S23, bending the base layer of the touch substrate at the non-touch function region, such that the connection pads in the connection region and the circuit board are on the side of the display panel away from the display face.

The touch display device produced by the method of the embodiments has a narrow frame, which can improve the user experience.

It should be noted that, in the present disclosure, relational terms such as first and second or the like are used merely to distinguish one entity or operation from another entity or operation, and do not necessarily require or imply there is any such actual relationship or order between these entities or operations. Furthermore, the terms “comprising” or “including” or any other variations thereof is intended to encompass a non-exclusive inclusion, such that a process, method, item, or device that comprises a plurality of elements includes not only those elements but also other elements that are not explicitly listed, or elements that are inherent to the process, method, item, or device. An element defined by the phrase “comprise a . . . ” without further limitation does not exclude the presence of additional identical elements in a process, method, item or device that comprises the element.

In accordance with the embodiments described above of the present disclosure, the embodiments are not described in detail, and are not intended to limit the invention to the specific embodiments. Obviously, many modifications and variations are possible in light of the above description. The present embodiments is chosen and described in detail in the present disclosure to explain the principles and practical applications of the present disclosure, so that those skilled in the art may make good use of the present disclosure and the modifications based on the present disclosure. The disclosure is limited only by the claims and the full scope and equivalents thereof.

What is claimed is:

1. A touch substrate comprising:
a base layer having a touch function region and a non-touch function region adjacent to at least one edge of the touch function region;
a plurality of touch electrodes disposed on the base layer and located in the touch function region; and
a plurality of connection pads disposed on the base layer and located in the non-touch function region, the plurality of connection pads being electrically connected to the plurality of touch electrodes through a plurality of wires, respectively,
wherein the base layer is bendable at the non-touch function region such that the plurality of connection pads are located on a side of the base layer away from the plurality of touch electrodes in response to the base layer being in a bent state.

2. The touch substrate of claim 1, wherein the non-touch function region comprises:
a first region adjacent to a first edge of the touch function region; and
a second region adjacent to the first region and located on a side of the first region away from the first edge,
wherein a size of the second region is smaller than a size of the first region in a direction in which the first edge extends, and
wherein the plurality of connection pads are disposed in the second region, and the base layer is bendable at the second region such that the base layer is in a bent state and the plurality of connection pads are located on the side of the base layer away from the plurality of touch electrodes in response to the base layer being in the bent state.

3. The touch substrate of claim 2, wherein the plurality of connection pads are arranged in the direction in which the first edge extends, and are spaced apart from each other, and a distance between the first edge and any one of the plurality of connection pads is greater than or equal to 0.9 mm.

4. The touch substrate of claim 2, wherein the second region is adjacent to a central portion of the first region, the central portion being located in the middle of the first region in the direction in which the first edge extends.

5. The touch substrate of claim 4, wherein the second region is in a shape of a rectangle.

6. The touch substrate of claim 1, wherein the plurality of touch electrodes comprise a plurality of first touch electrodes extending in a first direction and a plurality of second touch electrodes extending in a second direction.

7. The touch substrate of claim 6, wherein:
the plurality of first touch electrodes are driving electrodes, and the plurality of second touch electrode are sensing electrodes; or
the plurality of first touch electrode are sensing electrodes, and the plurality of second touch electrode are driving electrodes.

8. The touch substrate of claim 6, wherein:
each of the plurality of first touch electrodes comprises a plurality of first touch sub-electrodes arranged in the first direction, any two adjacent first touch sub-electrodes being electrically connected to each other; and
each of the plurality of second touch electrodes comprises a plurality of second touch sub-electrodes arranged in the second direction, any two adjacent second touch sub-electrodes being electrically connected to each other.

9. The touch substrate of claim 8, wherein each of the plurality of first touch sub-electrodes and each of the plurality of second touch sub-electrodes are disposed in a same layer, made of a same material and insulated from each other.

10. The touch substrate of claim 9, wherein any two adjacent first touch sub-electrodes are electrically connected by a first connection portion, the first connection portion and the plurality of first touch sub-electrodes being disposed in a same layer and made of the same material.

11. The touch substrate of claim 10, further comprising:
an insulating layer covering the first connection portion; and
a second connection portion on the insulating layer,
wherein any two adjacent second touch sub-electrodes are electrically connected by the second connection portion.

12. The touch substrate of claim 8, wherein at least one of the plurality of wires comprises a first conductive layer and a second conductive layer stacked on the first conductive layer.

13. The touch substrate of claim 12, wherein the first conductive layer, the plurality of first touch sub-electrodes and the plurality of second touch sub-electrodes are disposed in a same layer and made of a same material, and the second conductive layer comprises a metal material.

14. The touch substrate of claim 12, wherein an orthographic projection of the second conductive layer on the base layer falls within an orthographic projection of the first conductive layer on the base layer, and a line width of the second conductive layer is smaller than a line width of the first conductive layer.

15. The touch substrate of claim 9, wherein the base layer is made of a flexible material.

16. A touch display device comprising:
a display panel comprising a display face;
the touch substrate of claim 1 on the display face of the display panel, the side of the base layer away from the plurality of touch electrodes being arranged to face the display face; and
a circuit board bonded to the plurality of connection pads,
wherein the base layer is bendable at the non-touch function region such that the plurality of connection pads and the circuit board are located on the side of the base layer away from the plurality of touch electrodes in response to the base layer being in the bent state.

17. The touch display device of claim 16, wherein the touch substrate is adhered onto the display face by a transparent optical adhesive.

18. The touch display device of claim 16, wherein the display face comprises a display region, and an orthographic projection of the display region on the base layer falls within the touch function region of the base layer.

19. A method of fabricating a touch substrate, comprising:
adhering a base layer covered with a touch electrode material layer to a rigid substrate;
patterning the touch electrode material layer to form a plurality of touch electrodes in a touch function region of the base layer;
forming a plurality of connection pads and a plurality of wires in a non-touch function region of the base layer adjacent to at least one edge of the touch function region by a patterning process, the plurality of wires electrically connecting the plurality of connection pads with the plurality of touch electrodes; and
peeling off the rigid substrate.

20. The method of claim 19, further comprising:
cutting the base layer after peeling off the rigid substrate such that the non-touch function region comprises a first region adjacent to a first edge of the touch function region, and a second region adjacent to the first region and located on a side of the first region away from the first edge, a size of the second region being smaller than a size of the first region in a direction in which the first edge extends.
